(19) United States
(12) Patent Application Publication
(10) Pub. No.: US 2018/0362044 A1
(43) Pub. Date: Dec. 20, 2018

(54) VEHICLE CONTROL DEVICE

(71) Applicant: HITACHI AUTOMOTIVE SYSTEMS, LTD., Ibaraki (JP)

(72) Inventors: Yoichi IIHOSHI, Tokyo (JP); Toshio HORI, Hitachinaka-shi (JP); Kazuhiro ORYOJI, Tokyo (JP)

(73) Assignee: HITACHI AUTOMOTIVE SYSTEMS, LTD., Ibaraki (JP)

(21) Appl. No.: 15/781,332

(22) PCT Filed: Jan. 23, 2017
(86) PCT No.: PCT/JP2017/002046

§ 371 Date: Jun. 4, 2018

(30) Foreign Application Priority Data
Mar. 25, 2016 (JP) 2016-061082

(51) Int. Cl. B60W 30/18; F02D 41/30; F02D 41/00; F02D 41/04; B60W 10/02; B60W 10/06; F02P 5/04; B60W 20/40; F02D 43/00

(52) U.S. Cl. CPC B60W 30/18072; B60Y 2200/92; F02D 41/0077; F02D 41/042; B60W 10/02; B60W 10/06; F02D 41/0002; F02P 5/045; F02D 41/0087; B60W 20/40; F02D 43/00; F02D 2200/501; B60W 2710/021; B60W 2710/06; B60W 2710/0605; F02D 2200/0802; F02D 41/3005

(57) ABSTRACT

In a vehicle control device for stopping an internal combustion engine when a vehicle is traveling at a predetermined speed or higher and a stop condition of the internal combustion engine is satisfied, fuel is injected to the engine even when the stop condition is satisfied, when an EGR rate of the internal combustion engine is equal to or higher than a set value. Alternatively, when the EGR rate is equal to or higher than the set value, an EGR valve attached to an EGR pipe of the engine is controlled in a valve closing direction when the stop condition is satisfied. Alternatively, when the EGR rate is equal to or higher than the set value, clutch engagement is maintained for a clutch control device that disconnects torque transmission between an output shaft of the internal combustion engine and a vehicle drive shaft, even when the stop condition is satisfied.

### TECHNICAL FIELD

The present invention relates to a vehicle control device, particularly to a control technology for stop and restart of an internal combustion engine.

### BACKGROUND ART

In response to strengthening of CO2 regulation, an EGR control has been increasingly introduced, which reduces pump loss in a low load region and prevents knocking in a high load region by allowing exhaust gas of an internal combustion engine to reflow into a cylinder. If this EGR control and combustion stop control (stopping the internal combustion engine when the vehicle is stopped) are used together, restartability may be deteriorated. There is disclosed a technique of PTL 1 that solves this problem.

### CITATION LIST

### Patent Literature

PTL 1:JP 5585942 B2

### SUMMARY OF INVENTION

### Technical Problem

However, in PTL 1, consideration is not given to stopping the internal combustion engine while the vehicle is traveling. Moreover, when the EGR control and a sailing control (stopping the internal combustion engine while the vehicle is coasting) or a coasting control (stopping the internal combustion engine immediately before the vehicle is stopped while decelerating) are used together, there is a risk of deterioration of restartability.

The present invention is to solve the above-mentioned problems, and it is an object of the present invention to prevent deterioration of restartability in using the EGR control together with control (sailing control/coasting control) for stopping the internal combustion engine during traveling.

### Solution to Problem

To solve the above-mentioned problems, in the present invention, in a vehicle control device for stopping an internal combustion engine when a vehicle is traveling at a predetermined speed or higher and a stop condition of the internal combustion engine is satisfied, fuel is injected to the internal combustion engine even when the stop condition of the internal combustion engine is satisfied, when an EGR rate of the internal combustion engine is equal to or higher than a set value. Alternatively, when the EGR rate of the internal combustion engine is equal to or higher than the set value, an EGR valve attached to an EGR pipe of the internal combustion engine is controlled in a valve closing direction when the stop condition of the internal combustion engine is satisfied. Alternatively, when the EGR rate of the internal combustion engine is equal to or higher than the set value, clutch engagement is maintained for a clutch control device that disconnects torque transmission between an output shaft of the internal combustion engine and a vehicle drive shaft, even when the stop condition of the internal combustion engine is satisfied.

### Advantageous Effects of Invention

Applying the present invention enables prevention of deterioration of restartability due to the sailing control, the coasting control, the EGR control, or a combination of any of these controls. Description other than the above-described configuration, action, and effect of the present invention will be described in detail in the following examples.

### BRIEF DESCRIPTION OF DRAWINGS

FIG. 1 is an example of an internal combustion engine provided with an external EGR mechanism.

FIG. 2 is an example of a target external EGR rate map.

FIG. 3 is an example of a power transmission control system to stop and restart the internal combustion engine during traveling.

FIG. 4 is an example of a control block diagram for realizing the present invention.

FIG. 5 is an example of a flowchart for realizing the present invention.

FIG. 6 is an example of a time chart when the present invention is applied to a sailing control.

FIG. 7 is another example of the flowchart for realizing the present invention.

FIG. 8 is another example of the time chart when the present invention is applied to the sailing control.

FIG. 9 is another example of the flowchart for realizing the present invention.

FIG. 10 is another example of the time chart when the present invention is applied to the sailing control.

FIG. 11 is another example of the flowchart for realizing the present invention.

FIG. 12 is another example of the time chart when the present invention is applied to the sailing control.

FIG. 13 is an example of a flowchart for applying the present invention in accordance with a catalyst condition.

FIG. 14 is another example of the power transmission control system to stop and restart the internal combustion engine during traveling.

### DESCRIPTION OF EMBODIMENTS

Hereinafter, embodiments of the present invention will be described in detail with reference to the drawings.

### EXAMPLE 1

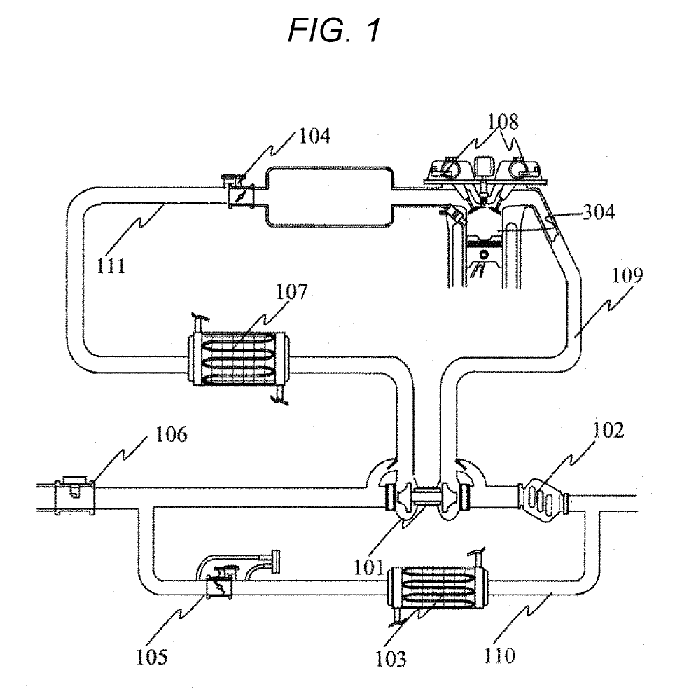

A method for improving deterioration of restartability of an internal combustion engine 304 by a vehicle control device 301 of the present invention will be described with reference to FIGS. 1 to 6.

FIG. 1 is an example of an internal combustion engine provided with an exhaust gas recirculation device. Hereinafter, this exhaust gas recirculation is simply referred to as an EGR. In this example, the internal combustion engine 304 provided with an external EGR mechanism will be particularly described. In this example, the internal combustion engine provided with the external EGR mechanism will be described as an example. However, the present invention is not limited to this, and other EGR mechanisms can be similarly applied.

A turbocharger 101 and a catalyst 102 are installed in an exhaust pipe 109, which is an exhaust flow passage of the internal combustion engine 304. The turbocharger 101 is constituted of: a turbine rotated by receiving a flow of exhaust gas; a shaft to transmit the rotation of the turbine); and a compressor that takes in air by using torque of the turbine to compresses the air. The turbocharger 101 serves as a supercharger that drives the compressor by using the flow of the exhaust gas to increase density of air taken in by the internal combustion engine 304.

The exhaust gas from the internal combustion engine 304 is purified by reduction and oxidation in the catalyst 102. The exhaust gas purified by the catalyst 102 is taken into an EGR pipe 110 from downstream of the catalyst 102, cooled by an EGR cooler 103, and returned to upstream of the turbocharger 101. A part of the combustion gas generated in a cylinder of the internal combustion engine 304 is recirculated to an intake pipe 111 via the EGR pipe 110, and mixed with intake air newly taken in from outside. A flow rate of the exhaust gas (EGR) to be recirculated in the EGR pipe 110 is determined by controlling an opening degree of an EGR valve 105. This control of the EGR achieves reduction of pumping loss while decreasing a combustion temperature of an air-fuel mixture in the cylinder, to reduce NOx emission.

The internal combustion engine 304 is controlled by a vehicle control device (not shown), a so-called engine control unit. An air flow rate sensor 106 detects a flow rate of fresh air newly taken in from outside. Although not shown, a pressure sensor is attached between the turbocharger 101 and the internal combustion engine 304, to detect a pressure of air in the intake pipe 111 that takes air into the internal combustion engine 304, or of air in a pipe of an intake chamber 112 downstream of the throttle. The flow rate of the mixed gas flowing from the intake pipe 111 to the internal combustion engine 304 is controlled by an opening degree of an intake throttle valve 104, and by a variable phase valve timing mechanism 108 that changes an opening/closing timing of an intake valve or an exhaust valve.

The vehicle control device of this example controls an actuator to realize a target EGR rate based on a detected value of the pressure sensor, the opening degree of the intake throttle valve 104, or the air flow rate sensor 106, which are described above. Meanwhile, in this example, the EGR rate refers to a ratio of fresh air and exhaust gas in the mixed gas flowing through the intake pipe 111. Then, the vehicle control device sets the opening degree of the EGR valve 105 or the intake throttle valve 104, or the phase angle of the intake and exhaust valves with the variable phase valve timing mechanism 108, and controls the EGR rate of the mixed gas flowing in via an intercooler 107.

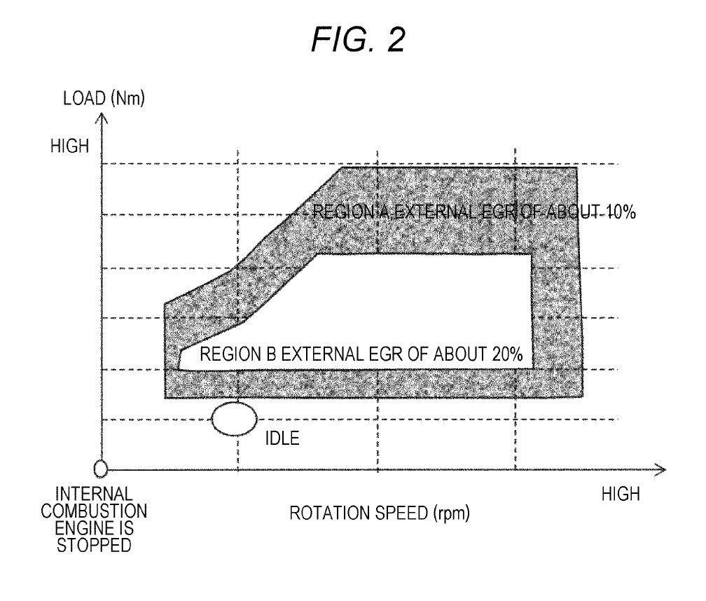

FIG. 2 is an example of a target external EGR rate map. The internal combustion engine 304 shown in FIG. 1 improves pump loss and heat loss by setting the external EGR to about 20% in a region B. That is, the target external EGR rate is determined in accordance with a rotation speed of the internal combustion engine 304 and a target load, and the vehicle control device controls each actuator described above such that the EGR rate of the mixed gas flowing in via the intercooler 107 becomes this target EGR rate, to widely open the throttle to reduce the pumping loss. Further, introduction of exhaust gas can also reduce a combustion temperature to reduce heat loss. On the other hand, the target external EGR rate is lowered to 10% or less in a low load region such as idle since the combustion becomes unstable to cause a risk of misfire if the EGR rate is high because an amount of fuel is small in the low load region. Similarly, for stopping the internal combustion engine 304, the external EGR rate is lowered to 10% or less to ensure restartability. While the external EGR rate is lowered also in the high load and high rotation region, this is because the external EGR is originally difficult to enter in this region, and furthermore, the above-mentioned pump loss is originally small. Rather, the external EGR is introduced to reduce knocking in this region, and the EGR rate may be determined by its effect margin.

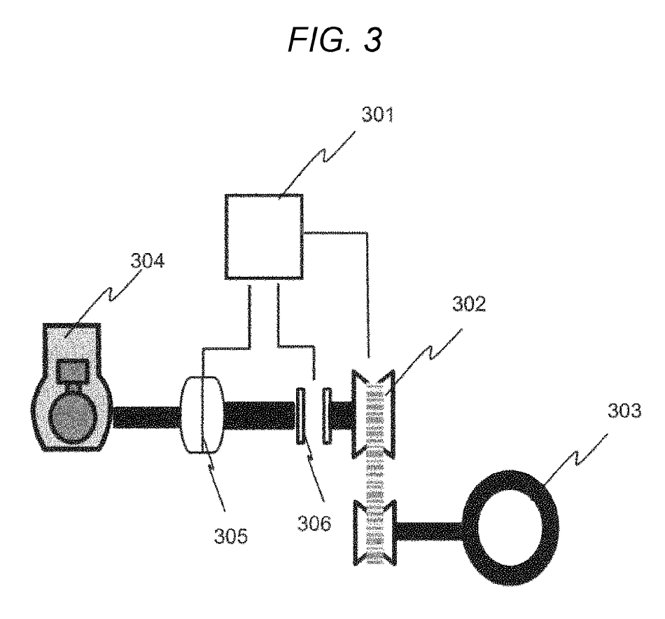

FIG. 3 shows an example of a power transmission control system to stop and restart the internal combustion engine 304 during traveling. Power generated by the internal combustion engine 304 is transmitted to a drive wheel 303 via a torque converter 305, a clutch 306, and a CVT 302. The clutch 306 is a torque transmission mechanism that transmits or interrupts torque by engaging or releasing an output shaft of the internal combustion engine 304 and a vehicle drive shaft, and is controlled by a control unit (CPU) of the vehicle control device. The CVT 302 is a stepless transmission or a continuously variable transmission, which is a power transmission mechanism that continuously changes a gear ratio by using a mechanism other than gears.

Here, a description is given to a sailing control for stopping an engine during deceleration traveling of a vehicle in order to reduce fuel consumption. More particularly, a traveling scene having a fuel efficiency effect is identified using external information such as a preceding vehicle, and the sailing control is executed when the vehicle is decelerating in such a traveling scene. In the sailing control, for example, when the driver turns off an accelerator and the vehicle starts coasting, the control unit (CPU) provided to the vehicle control device 301 performs a control to disconnect the clutch 306 such that power of the internal combustion engine 304 is not transmitted to the drive wheel 303. Then, after disconnecting the clutch 306, the control unit (CPU) controls a fuel injection valve (injector) (not shown) to stop the fuel injection of the internal combustion engine 304. This enables improvement of fuel efficiency.

Further, a coasting control refers to a control for similarly disengaging the clutch 306, and a control of the fuel injection valve (injector) (not shown) to stop the fuel injection of the internal combustion engine 304 when the driver depresses a brake and a vehicle speed becomes lower than a predetermined value. This aims to improve fuel efficiency similarly to the sailing control described above. Although this example will be described using the CVT 302, the present invention can be realized without change even when a transmission such as an ANT or an MT is used. Moreover, the stop condition of the internal combustion engine in the sailing control and the coasting control is not limited to those described above, and the internal combustion engine 304 may be stopped under a condition that an output of the internal combustion engine 304 is set zero during traveling by an external request in “constant speed travel/vehicle distance control” called adaptive cruise control (ACC). Note that the ACC is an automatic control that keeps a distance between vehicles constant on highways, expressways, and the like, and allows constant speed travel of the vehicle.

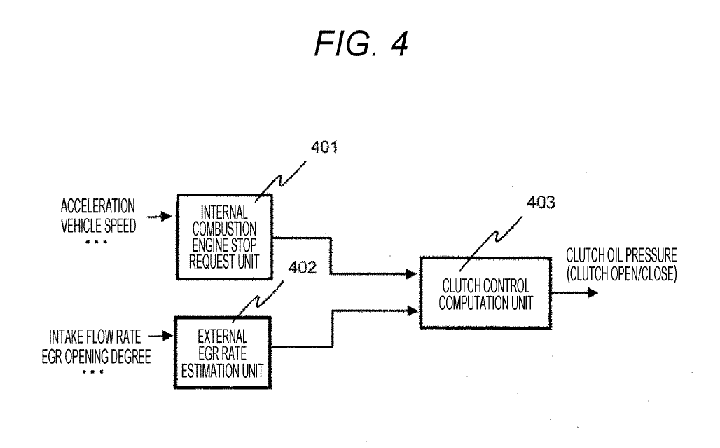

FIG. 4 is an example of a control block diagram for realizing this example, and shows a functional block diagram executed by the control unit (CPU) provided to the vehicle control device 301. The control unit (CPU) of the vehicle control device 301 has: an internal combustion engine stop request unit 401 that calculates a stop request for the internal combustion engine based on an acceleration signal, a vehicle speed signal, and the like; and an external EGR rate estimation unit 402 that estimates the external EGR rate to be taken into the cylinder of the internal combustion engine 304 based on an intake flow rate, an EGR valve opening degree, and the like. For example, it is assumed that the internal combustion engine 304 is stopped although the external EGR rate is high (e.g., 30%) when there is an internal combustion engine stop request. That is, when the internal combustion engine 304 is stopped by releasing the clutch 306 and setting the fuel injection amount to zero, and thereafter the internal combustion engine start condition is satisfied again, there is a possibility that restarting cannot be performed due to high external EGR rate when the clutch 306 is engaged and fuel injection is started.

Therefore, in this example, a clutch control computation unit 403 of the control unit (CPU) controls a clutch oil pressure to engage the clutch 306 or maintain the clutch engagement when an external EGR estimate (EGR rate) is equal to or higher than the set value even when there is the internal combustion engine stop request. Then, when the EGR rate becomes lower than the set value and there is the internal combustion engine stop request, the clutch control computation unit 403 of the control unit (CPU) controls the clutch oil pressure such that the clutch is released or the clutch release is maintained. This makes it possible to suppress deterioration of restartability of the internal combustion engine due to high external EGR rate, and to reduce fuel consumption by appropriately stopping the internal combustion engine when the external EGR rate is low.

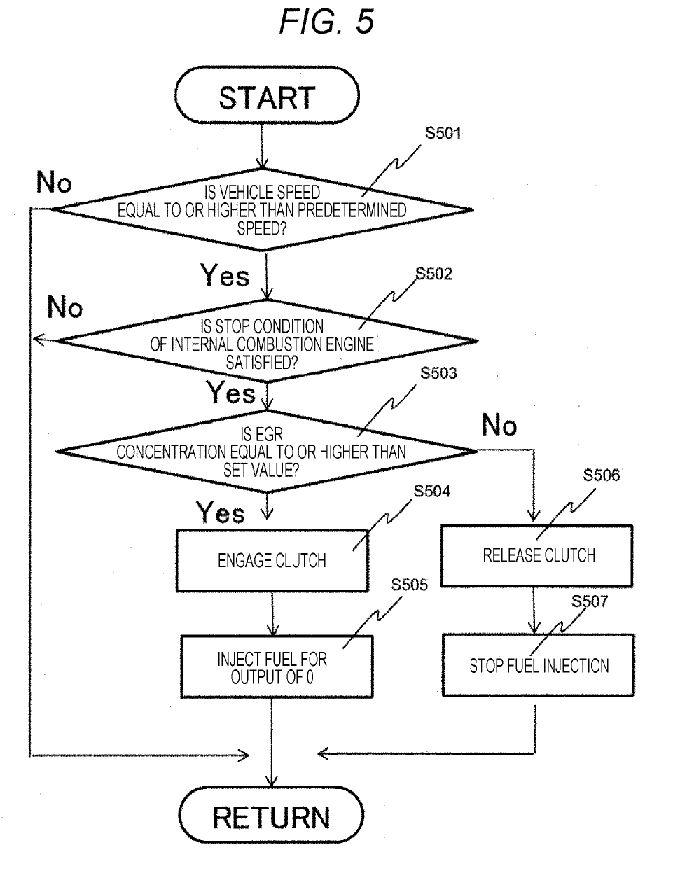

FIG. 5 is an example of a flowchart of this example executed by the functional block of the control unit (CPU) of the vehicle control device 301 described above. In step S501, it is determined by the internal combustion engine stop request unit 401 of the control unit (CPU) whether a vehicle speed is equal to or higher than a predetermined speed. When the vehicle speed is equal to or higher the predetermined speed (e.g. 5 km/h), the process proceeds to step S502. In step S502, it is determined whether the stop condition of the internal combustion engine is satisfied. When the condition is satisfied, the control unit (CPU) controls the fuel injection valve to stop fuel injection of the internal combustion engine 304. Further, in this case, the process proceeds to step S503.

As the stop condition of the internal combustion engine, for example, a case may be considered where the accelerator is turned off, for driving by a driver in the sailing control. For the ACC, it is conceivable to set a state where a request torque is zero, as the stop condition of the internal combustion engine. Alternatively, for the ACC, the stop condition of the internal combustion engine may be a case where the request torque is negative and the vehicle is to be stopped after a predetermined time. Further, for the coasting control, for example, a case where the brake is ON for driving by the driver and the vehicle speed is equal to or lower than a coasting permission speed (e.g., 15 km/h) may be set as the stop condition of the internal combustion engine.

In step S503, the external EGR rate estimation unit 402 of the control unit (CPU) estimates or calculates the external EGR rate. When the external EGR rate is equal to or higher than the set value (e.g., 5%), the process proceeds to step S504, otherwise the process proceeds to step S506. Clutch engagement is maintained in step S504, and fuel is injected such that shaft horsepower of the internal combustion engine becomes close to zero in step S505. That is, the control unit (CPU) maintains the clutch engagement to inhibit stop of the internal combustion engine 304, and controls the shaft horsepower of the internal combustion engine 304 to be close to zero to realize a deceleration similar to that of when the clutch 306 is disconnected, without generating a brake (engine brake) by the internal combustion engine 304. On the other hand, if the EGR concentration becomes lower than a predetermined value, the process proceeds to step S506. In step S506, the control unit (CPU) releases the clutch 306, and stops the internal combustion engine 304 by controlling the fuel injection valve to stop the fuel injection in step S507. This enables improvement of fuel efficiency by running the vehicle with the internal combustion engine stopped in a sailing drive state.

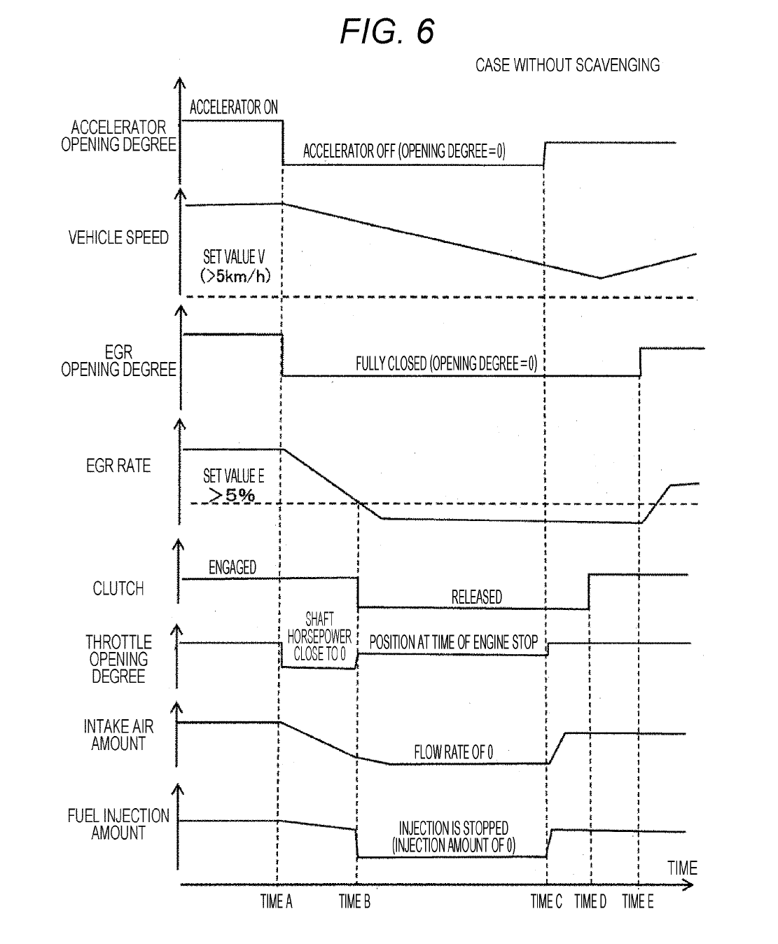

FIG. 6 is an example of a time chart when this example is applied to the sailing control. Assuming that the stop condition of the internal combustion engine 304 is satisfied when the vehicle is traveling at a predetermined speed or higher and when the driver turns the accelerator from on to off (time A), in this case, the control unit (CPU) originally controls the internal combustion engine 304 to stop. That is, it is conceivable that the control unit (CPU) stops the internal combustion engine 304 by releasing the clutch 306 and setting the fuel injection amount to zero.

However, when the external EGR rate of the internal combustion engine 304 is equal to or higher than the set value (e.g. 5%) here, the control unit (CPU) of this example controls the fuel injection valve to inject fuel to the internal combustion engine 304 even when the stop condition of the internal combustion engine 304 is satisfied, and continues driving without stopping the internal combustion engine 304. At this time, the control unit (CPU) performs a control to maintain the clutch engagement for the clutch that transmits or disconnects torque between the output shaft 304 of the internal combustion engine and the vehicle drive shaft.

In addition, the control unit (CPU) controls the intake throttle valve 104 in the valve closing direction to set the shaft horsepower close to zero, and further controls the EGR valve 105 in the valve closing direction to lower the external EGR rate. Specifically, when reducing the opening degree of the intake throttle valve 104, the control unit (CPU) controls the opening degree of the intake throttle valve 104 to be more open than that at a time of fuel cut when the stop condition of the internal combustion engine 304 is not satisfied, to set the shaft horsepower from the internal combustion engine 304 to be close to zero (an output at which the internal combustion engine can maintain the rotational speed). This can achieve a deceleration similar to that by the clutch release even when the clutch 306 is engaged, allowing this control to be carried out without giving a sense of discomfort to the driver.

When the external EGR rate becomes lower than the set value (time B), the control unit (CPU) releases the clutch 306 and stops the internal combustion engine 304 by setting the fuel injection amount to zero. When the driver next depresses the accelerator pedal, the internal combustion engine is restarted (time C). When a difference between a rotational speed of the internal combustion engine and a rotational speed of the transmission falls within a predetermined range, the clutch 306 is engaged (time D). Then, the EGR valve is opened in accordance with a load of the internal combustion engine, and the external EGR is introduced (time E), thereby to realize low fuel consumption driving. With this configuration, even when the EGR rate is higher than the set value, deterioration of restartability can be prevented and sense of discomfort to the driver can be prevented since the deceleration also does not change.

### EXAMPLE 2

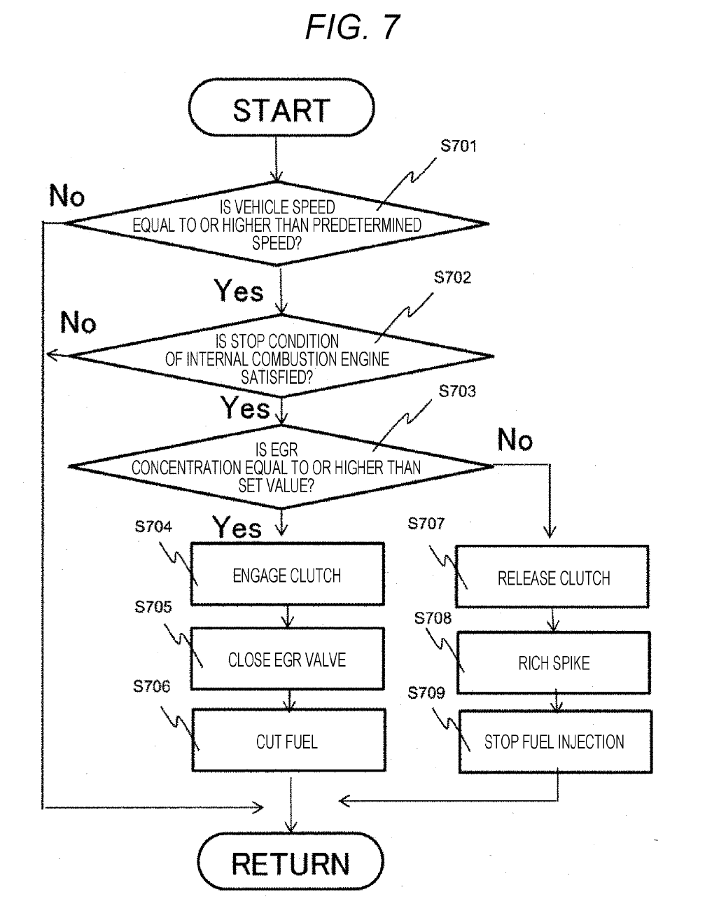

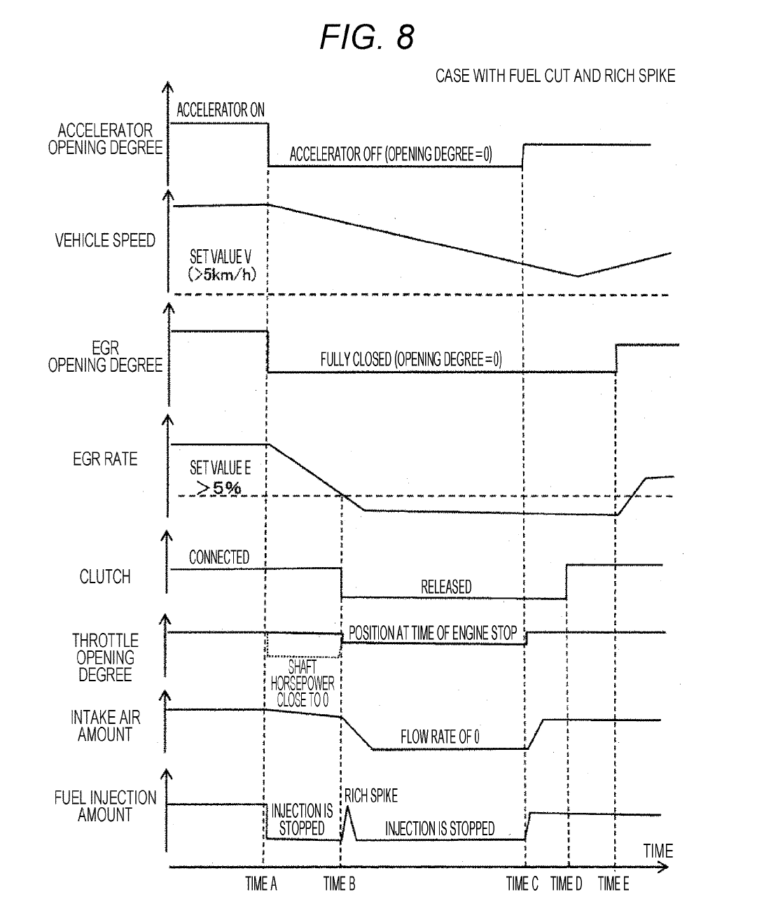

Another embodiment of the present invention for the system described in FIGS. 1 to 4 will be described with reference to FIGS. 7 and 8

FIG. 7 is an example of a flowchart of this example executed by a functional block of a control unit (CPU) of a vehicle control device 301. The description of steps S701 to S703 will be omitted since it is the same as the description of steps S501 to S503 of FIG. 5. Steps S704 to S705 are executed by the control unit (CPU) when a stop condition of the internal combustion engine 304 is satisfied but an EGR concentration is equal to or higher than a set value. In step S704, the control unit (CPU) controls the clutch 306 to engage the clutch or maintain the engagement, and controls an EGR valve 105 to be closed in step S705.

Further, in step S706, the control unit (CPU) stops fuel injection in all cylinders, and controls an intake throttle valve 104 in a valve opening direction. At this time, since an inertial force (rotation of a tire) of the vehicle is transmitted to the internal combustion engine through the clutch 306, the rotation of the internal combustion engine is maintained even when fuel is injected. Further, controlling the intake throttle valve 104 in the valve opening direction with the control unit (CPU) almost eliminates engine brake to be applied, which can achieve substantially the same deceleration as when the internal combustion engine is stopped.

Whereas, steps S707 to S709 are executed by the control unit (CPU) when the stop condition of the internal combustion engine 304 is satisfied and an EGR rate is lower than a set value. Here, in step S707, the control unit (CPU) releases the clutch 306, and controls the fuel injection valve to execute rich spike control (injecting dense fuel as compared with a stoichiometric ratio) for consuming oxygen accumulated in a catalyst, in step S708. Then, after completion of this rich spike control, the control unit (CPU) controls the fuel injection valve to stop the fuel injection in step S709.

FIG. 8 is another example of a time chart when the present invention is applied to a sailing control. A difference from FIG. 6 is that fuel injection is stopped at the time A where the accelerator is turned off, and an opening degree of the intake throttle valve 104 is opened or maintained to be larger than when the shaft horsepower is close to zero, to such an extent that engine brake is not applied. That is, when controlling the EGR valve 105 in the valve closing direction, the control unit (CPU) cuts off the fuel and performs a control to open the opening degree of the intake throttle valve 104 more than that at a time of fuel cut when the stop condition of the internal combustion engine 304 is not satisfied.

This increases the intake flow rate flowing into the cylinder of the internal combustion engine 304 as compared with that of when this control is not executed, and lowers the EGR rate more quickly. Further, in this method, since oxygen is stored in the catalyst, the internal combustion engine is stopped after injecting fuel for rich spike fuel injection to eliminate the oxygen before and after disengagement of the clutch 306.

In this example, the rich spike control is performed after the clutch 306 is released, which can prevent deterioration of drivability since combustion torque at a time of the rich spike is not transmitted to the wheels. With this configuration, when the EGR rate is higher than the set value, inhibiting stop of the internal combustion engine and accelerating the reduction in the EGR rate allow an execution time of the sailing drive to be prolonged, which can achieve reduction in the fuel consumption. Finally, removing the oxygen stored in the catalyst with rich spike can prevent deterioration of exhaust gas (especially NOx) at reacceleration (time D and later) after restart of the engine.

### EXAMPLE 3

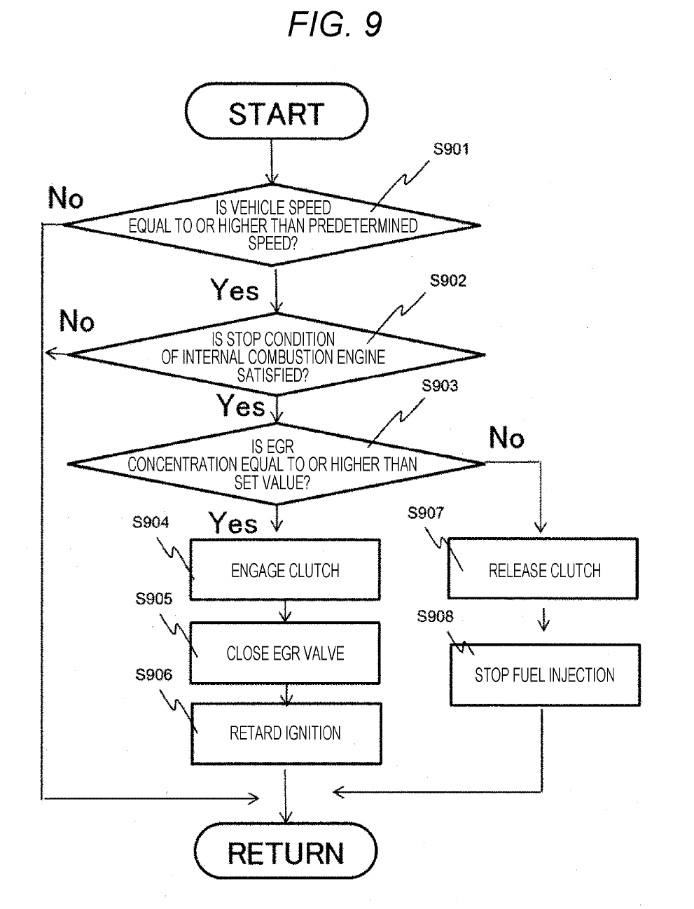

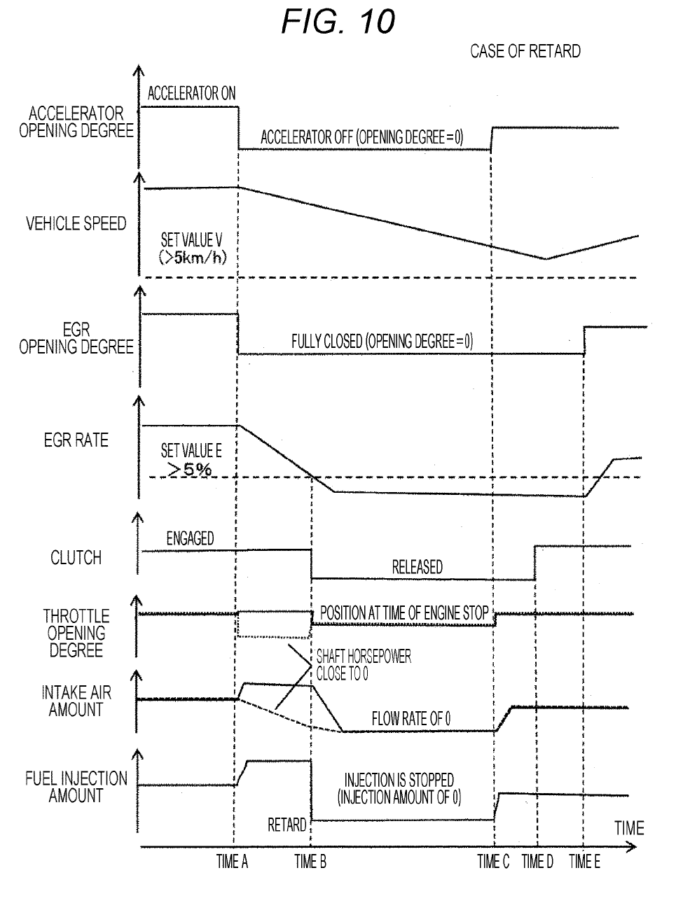

Another embodiment of the present invention for the system described in FIGS. 1 to 4 will be described with reference to FIGS. 9 and 10.

FIG. 9 is an example of a flowchart of this example executed by a functional block of a control unit (CPU) of a vehicle control device 301. The description of steps S901 to S903 will be omitted since it is the same as the description of steps S501 to S503 of FIG. 5. Steps S904 to S906 are executed by the control unit (CPU) when a stop condition of the internal combustion engine is satisfied but an EGR concentration is equal to or higher than a set value. In step S904, the control unit (CPU) controls a clutch 306 to engage the clutch or maintain the engagement, and controls an EGR valve 105 to be closed in step S905.

In step S806, while the control unit (CPU) opens an intake throttle valve 104, torque increases accordingly. Here, although not shown, the internal combustion engine 304 is disposed with an ignition plug that ignites injected fuel, and an ignition timing of the ignition plug is controlled by the control unit (CPU) of the vehicle control device. Then, the control unit (CPU) controls the ignition plug to perform so-called ignition retard, which retards the ignition timing in order to reduce the above-mentioned increasing torque. Whereas, when the EGR concentration becomes lower than the set value, steps S907 to S908 are performed. Here, in step S907, the control unit (CPU) releases the clutch 306 and controls the fuel injection valve to stop fuel injection in step S908.

FIG. 10 is another example of a time chart when this example is applied to a sailing control. A difference from FIG. 6 is to increase an intake air amount by increasing the opening degree of the intake throttle valve 104 as compared with an opening degree when the shaft horsepower is set close to zero, after the accelerator is turned off (time A). At this time, the control unit (CPU) increases the fuel injection amount while suppressing the increasing output torque of the internal combustion engine 304, by controlling the ignition plug to perform the ignition retard. That is, when controlling the internal combustion engine 304 not to stop, the control unit (CPU) performs a control to retard ignition and open the opening degree of the intake throttle valve more than before the ignition retard. This increases an intake flow rate flowing into a cylinder of the internal combustion engine 304 as compared with that of when this control is not executed, and lowers an EGR rate more quickly. Further, by performing the ignition retard in accordance with the intake flow rate to suppress generation of extra torque, deterioration of drivability can also be prevented.

With this example, when the EGR rate is higher than the set value, inhibiting stop of the internal combustion engine and accelerating the reduction in the EGR rate allow an execution time of the sailing drive to be prolonged, which can achieve reduction in the fuel consumption. Further, deterioration of drivability can be prevented by performing torque control with ignition retard.

### EXAMPLE 4

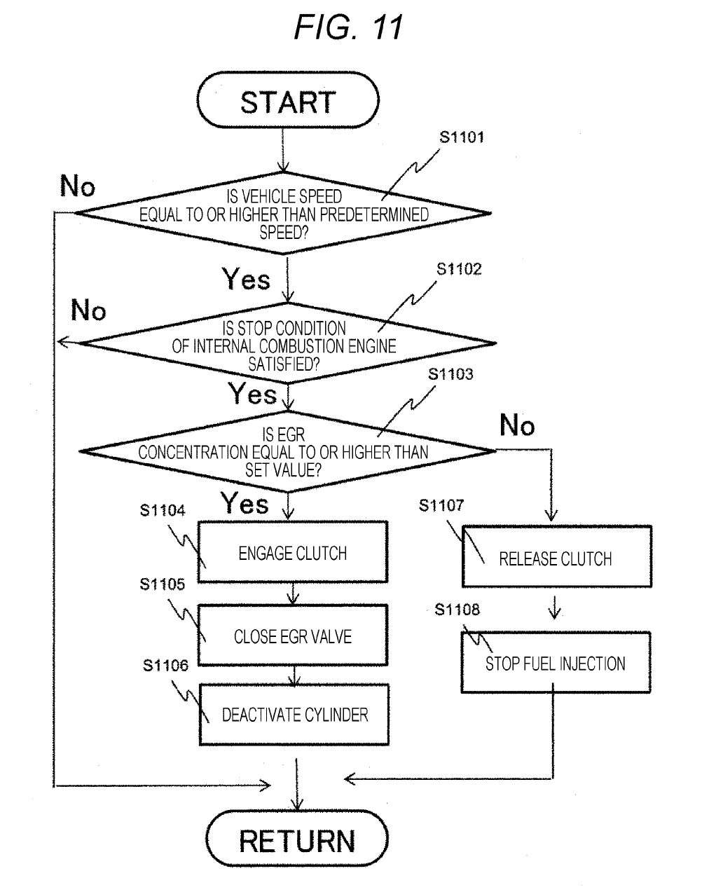

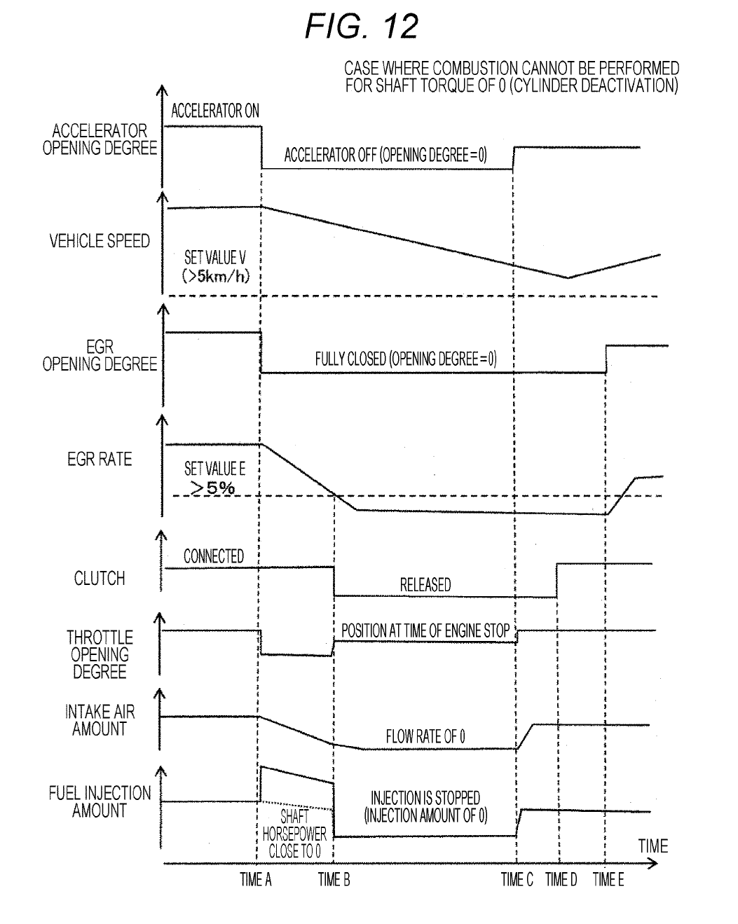

Another embodiment of the present invention for the system described in FIGS. 1 to 4 will be described with reference to FIGS. 11 and 12.

FIG. 11 is an example of a flowchart of this example executed by a functional block of a control unit (CPU) of a vehicle control device 301. The description of steps S1101 to S1102 will be omitted since it is the same as the description of steps S501 to S502 of FIG. 5. Steps S1104 to S1105 are executed when a stop condition of an internal combustion engine 304 is satisfied but an EGR concentration is equal to or higher than a set value. In step S1104, the control unit (CPU) controls a clutch 304 to engage the clutch or maintain the engagement, and controls an EGR valve 105 to be closed in step S1105. In addition, the control unit (CPU) performs a control to deactivate a cylinder in step S1106. Specifically, a variable valve mechanism stops an inflow of an air-fuel mixture to a deactivated cylinder, and instead, the air-fuel mixture that should originally flow into the deactivated cylinder is introduced to a combustion cylinder.

This control is executed when combustion for shaft horsepower close to zero becomes difficult with combustion performed in all the cylinders, and the combustion stability is ensured by increasing an air amount and a fuel amount in the combustion cylinder to increase the fuel amount in the combustion cylinder. As a result, even when the EGR rate is high and combustion for shaft horsepower close to zero is difficult with combustion performed in all the cylinders, the air and fuel for the deactivated cylinder can be distributed to the remaining cylinders to prevent combustion deterioration, and torque fluctuation giving sense of discomfort to the driver can be prevented.

FIG. 12 is another example of a time chart when this example is applied to a sailing control. A difference from FIG. 6 is that the cylinder is deactivated after the accelerator is turned off (time A), so that the fuel amount of the fuel injection cylinder is increased more than when the shaft horsepower is close to zero. Then, the clutch is released when the ERG rate becomes lower than the set value, the throttle opening degree is returned to a position at a time of stopping the engine, and the fuel injection amount is stopped. With this configuration, it is possible to realize the same deceleration as during a sailing drive and to prevent discomfort given to the driver, by inhibiting stop of the internal combustion engine when the EGR rate is higher than the set value, and by assuring combustion stability with cylinder deactivation even when combustion for the shaft horsepower is close to zero cannot be realized with combustion performed in all cylinders.

### EXAMPLE 5

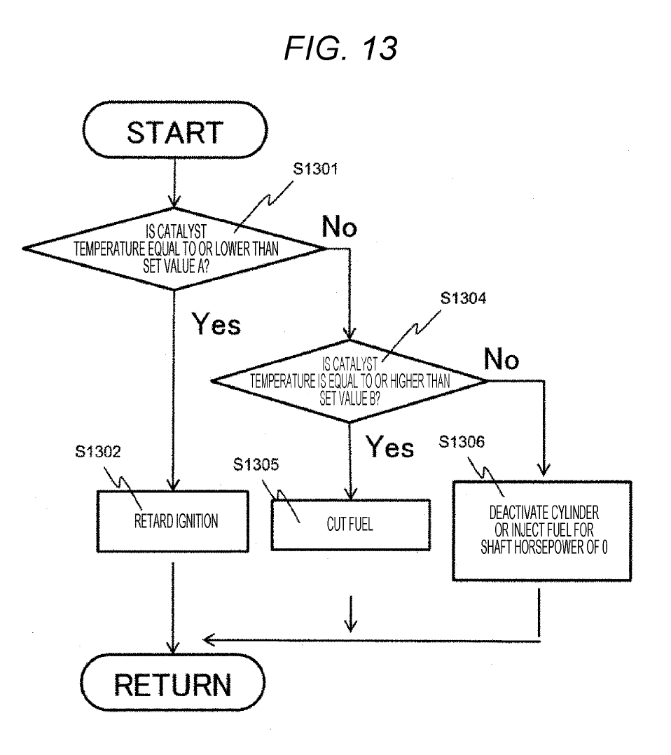

Another embodiment of the present invention for the system and control described in FIGS. 1 to 12 will be described with reference to FIG. 13.

FIG. 13 is an example of a flowchart of this example executed by a functional block of a control unit (CPU) of a vehicle control device 301. This flowchart shows a method of selecting the control before the internal combustion engine is stopped, which has been described in Examples 1, 2, 3, and 4, according to a catalyst temperature. In step S1301, it is determined whether the catalyst temperature (actual measured value or estimated value) is equal to or lower than a set value A that is set for preventing reduction of the catalyst temperature. When it is equal to or lower than the set value, the process proceeds to step S1302, otherwise the process proceeds to step S1304. In step S1302, the ignition retard shown in Example 3 is performed before sailing, and an exhaust temperature is raised by the ignition retard to increase the catalyst temperature. In step S1304, it is determined whether the catalyst temperature is equal to or higher than a set value B that is set for preventing catalyst damage. When it is equal to or higher than the set value B, the process proceeds to step S1305, otherwise the process proceeds to step S1306. In step S1305, the catalyst temperature is lowered by feeding intake air into the catalyst by fuel cut. In step S1306, the combustion injection for shaft horsepower of zero shown in Example 1 and the cylinder deactivation shown in Example 4 are selected according to combustion stability.

This configuration can prevent the catalyst temperature from becoming lower than an activation temperature or higher than a catalyst damage temperature, and can stop the internal combustion engine while maintaining exhaust performance of the catalyst.

### EXAMPLE 6

The invention described in Examples 1 to 5 can also be applied to a hybrid system of an internal combustion engine and a motor.

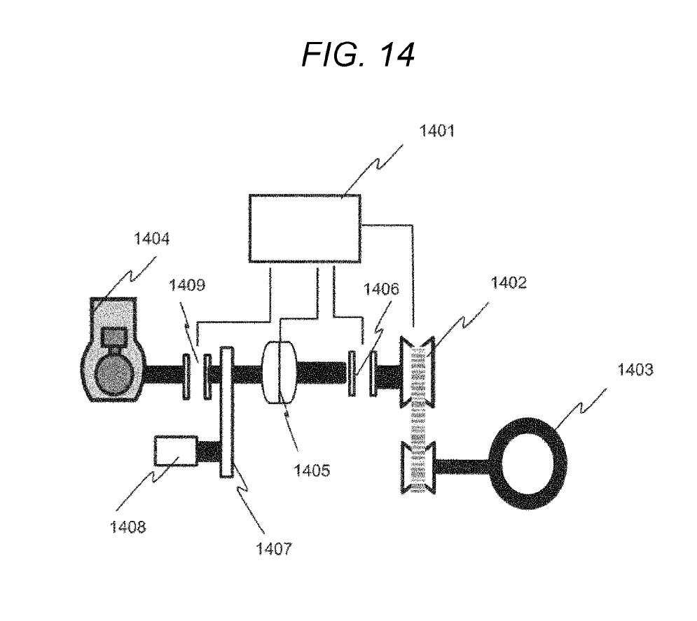

FIG. 14 is another example of a power transmission control system to stop and restart an internal combustion engine during traveling. A difference from FIG. 3 is that power of a motor 1408 can be transmitted to a tire through a belt 1407, and there is provided a clutch B1409 to enable traveling by the motor 1408 alone. As a condition for traveling by the motor alone and stopping the internal combustion engine, there may be a case where the internal combustion engine is in a low-efficiency operation region and the motor can be driven alone, or a case where the motor alone is driven in order to secure a battery storage amount at a time of regeneration. In this system, an internal combustion engine 1404 is stopped during traveling with the motor alone, but when an EGR rate is high as described above, restartability of the internal combustion engine 1404 is deteriorated. A method for avoiding this is the same as the case described in Examples 1 to 4. Deterioration of restartability can be prevented by engaging the clutch B1409 and the clutch A1406 even when the stop condition of the internal combustion engine is satisfied, and by performing fuel injection for shaft horsepower of zero, fuel cut, ignition retard, or cylinder deactivation.

### REFERENCE SIGNS LIST

101 turbocharger

102 catalyst

103 EGR cooler

104 intake throttle

105 EGR valve

106 air flow rate sensor

107 intercooler

108 variable phase valve timing mechanism

301 control device

302 CVT

303 drive wheel

304 internal combustion engine

305 torque converter

306 clutch

401 internal combustion engine stop request unit

402 external EGR rate estimation unit

403 clutch control computation unit

1401 control device

1402 CVT

1403 drive wheel

1404 internal combustion engine

1405 torque converter

1406 clutch

A1407 belt

1408 motor

1409 clutch B

1. A vehicle control device for stopping an internal combustion engine when a vehicle is traveling at a predetermined speed or higher and a stop condition of the internal combustion engine is satisfied, the vehicle control device comprising:
a control unit that controls a fuel injection valve to perform fuel injection to the internal combustion engine even when the stop condition of the internal combustion engine is satisfied, when an EGR rate of the internal combustion engine is equal to or higher than a set value.

2. A vehicle control device for stopping an internal combustion engine when a vehicle is traveling at a predetermined speed or higher and a stop condition of the internal combustion engine is satisfied, the vehicle control device comprising:
a control unit that controls an EGR valve attached to an EGR pipe of the internal combustion engine in a valve closing direction when the stop condition of the internal combustion engine is satisfied, when an EGR rate of the internal combustion engine is equal to or higher than a set value.

3. A vehicle control device for stopping an internal combustion engine when a vehicle is traveling at a predetermined speed or higher and a stop condition of the internal combustion engine is satisfied, the vehicle control device comprising:
a control unit that controls a clutch that transmits or disconnects torque between an output shaft of the internal combustion engine and a vehicle drive shaft to maintain clutch engagement even when the stop condition of the internal combustion engine is satisfied, when an EGR rate of the internal combustion engine is equal to or higher than a set value.

4. The vehicle control device according to claim 3, wherein
the control unit performs a control to stop the internal combustion engine by sending a clutch release instruction to a clutch that disconnects torque transmission between the output shaft of the internal combustion engine and the vehicle drive shaft, when the stop condition of the internal combustion engine is satisfied.

5. The vehicle control device according to claim 2, wherein
when the control unit controls the EGR valve attached to the EGR pipe of the internal combustion engine in the valve closing direction, the control unit performs a control to cut fuel and to open an opening degree of a throttle valve attached to an intake pipe of the internal combustion engine more than that at a time of fuel cut when the stop condition of the internal combustion engine is not satisfied.

6. The vehicle control device according to claim 3, wherein
when the control unit controls a clutch that disconnects torque transmission between the output shaft of the internal combustion engine and the vehicle drive shaft to maintain clutch engagement, the control unit performs a control to cut fuel and to open an opening degree of a throttle valve attached to an intake pipe of the internal combustion engine more than that at a time of fuel cut when the stop condition of the internal combustion engine is not satisfied.

7. The vehicle control device according to claim 3, wherein
when the control unit controls the internal combustion engine not to stop, the control unit performs a control to retard ignition, and to open an opening degree of a throttle valve attached to an intake pipe of the internal combustion engine more than that before ignition retard.

8. The vehicle control device according to claim 3, wherein
when the control unit controls the internal combustion engine not to stop, the control unit performs a control to stop fuel injection of a predetermined cylinder for partial fuel cut, and to inject fuel in an amount corresponding to an amount for a deactivated cylinder, into the cylinder in which injection is stopped.

9. The vehicle control device according to claim 3, wherein
at least one of ignition retard, fuel cut, and partial fuel cut is selected according to a catalyst temperature of a catalyst that purifies exhaust gas of the internal combustion engine.

10. The vehicle control device according to claim 3, wherein
the stop condition of the internal combustion engine is a permission condition of a sailing drive to disconnect torque transmission between the output shaft of the internal combustion engine and the vehicle drive shaft during vehicle coasting.

11. The vehicle control device according to claim 3, wherein
the stop condition of the internal combustion engine is a permission condition of a coasting drive to disconnect torque transmission between the output shaft of the internal combustion engine and the vehicle drive shaft immediately before stop of the vehicle.

12. The vehicle control device according to claim 3, wherein
the stop condition of the internal combustion engine is a permission condition of a motor drive to disconnect torque transmission between the output shaft of the internal combustion engine and the vehicle drive shaft to run the vehicle with motor power.

13. The vehicle control device according to claim 3, wherein
after controlling the internal combustion engine not to stop, the control unit controls the internal combustion engine to stop when the EGR rate of the internal combustion engine becomes lower than the set value.
